(19) United States
(12) Patent Application Publication
(10) Pub. No.: US 2009/0147240 A1
(43) Pub. Date: Jun. 11, 2009

(54) METHOD AND SYSTEM FOR EYE SAFETY IN OPTICAL SENSOR SYSTEMS

(75) Inventor: Paul E. Bauhahn, Fridley, MN (US)

Correspondence Address: HONEYWELL INTERNATIONAL INC., 101 COLUMBIA ROAD, P O BOX 2245, MORRISTOWN, NJ, 07962-2245, US

(73) Assignee: Honeywell International Inc., Morristown, NJ (US)

(21) Appl. No.: 11/952,319

(22) Filed: Dec. 7, 2007

(51) Int. Cl. G01C 3/08; G01C 3/00

(52) U.S. Cl. 356/5.01

(57) ABSTRACT

One embodiment of the application provides a method and system for measuring a range to a target using a ranging system by measuring the time of flight of a ranging signal to and from the target, the first ranging signal having an energy sufficient to locate the target and detecting the target using a detection system generating a target detection signal, the target detection signal having a peak energy determined by the range to the target measured by the first detection system.

### TECHNICAL FIELD

The present application relates generally to optical range sensor systems.

### BACKGROUND

Optical sensor systems allow for remote sensing of a distance to a target. They generally include a transmitter and a receiver. In such systems electromagnetic energy may be transmitted from a transmitter and reflected back to a receiver from the remote target.

### BRIEF DESCRIPTION OF THE DRAWINGS

Some embodiments are illustrated by way of examples, and not by way of limitations, in the figures of the accompanying drawings in which:

FIG. 1 illustrates a block diagram of an optical sensor system, according to an example embodiment.

FIG. 2 illustrates a block diagram of the optical sensor system in FIG. 1, according to an example embodiment.

FIG. 3 illustrates a block diagram of an integrated sensor system using acoustic and optical signals, according to an example embodiment.

FIG. 4 is a flowchart illustrating a method of providing eye-safety during optical sensing of targets, according to an example embodiment.

FIG. 5 is a block diagram illustrating a system controller in the example form of a computer system, within which a set of sequence of instructions for causing the machine to perform any one of the methodologies discussed herein may be executed.

### DETAILED DESCRIPTION

In the following description, for purposes of explanation, numerous specific details are set forth in order to provide a thorough understanding of example embodiments. The following detailed description includes reference to the accompanying drawings, by way of illustration, specific embodiments in which the invention may be practiced. The embodiments may be combined, other embodiments may be utilized, or structural, logical and electrical changes may be made without departing from the scope of the present invention. The following detailed description is, therefore not to be taken in the limiting sense, and the scope of the present invention is defined by the appended claims and their equivalents. It will be evident, however, to one skilled in the art that the embodiments of the application may be practiced without these specific details.

In this document, the terms “a” or “an” are used, as is common in patent documents, to include one or more than one. In this document, the term “or” is used to refer to a nonexclusive or, unless otherwise indicated. In some systems, transmission of electromagnetic radiation during sensing of remote targets may affect the vision of personnel situated close to the target being sensed or to the beam of energy between the transmitter and the sensor. FIG. 1 is a block diagram illustrating the configuration of an optical range sensor system 100, according to an example embodiment. Optical range sensor system 100 includes a system controller 110, a laser 108, a transmitter/receiver and focusing system 104 and a detector 106. Also shown in FIG. 1 is a target 102 that may be located at a distance from the transmitter/receiver focusing system 104. In some embodiments, laser 108 may either be built to emit a continuous beam using a laser operating in the continuous wave (CW) mode or to emit a train of short pulse using a pulsed laser. In the continuous wave (CW) mode of operation, the output of the laser 108 is relatively consistent with respect to time.

In some embodiments, transmitter/receiver focusing optics 104 includes focusing optics to help focus on target 102 for target identification. In some embodiments, laser 108 includes a light emitting diode. In some embodiments, detector 106 includes a photodiode to detect electromagnetic radiation reflected by the target. In some embodiments, the system controller 110 adjusts focusing optics 104 to maximize returned signal and then estimates range to control the power of laser 108.

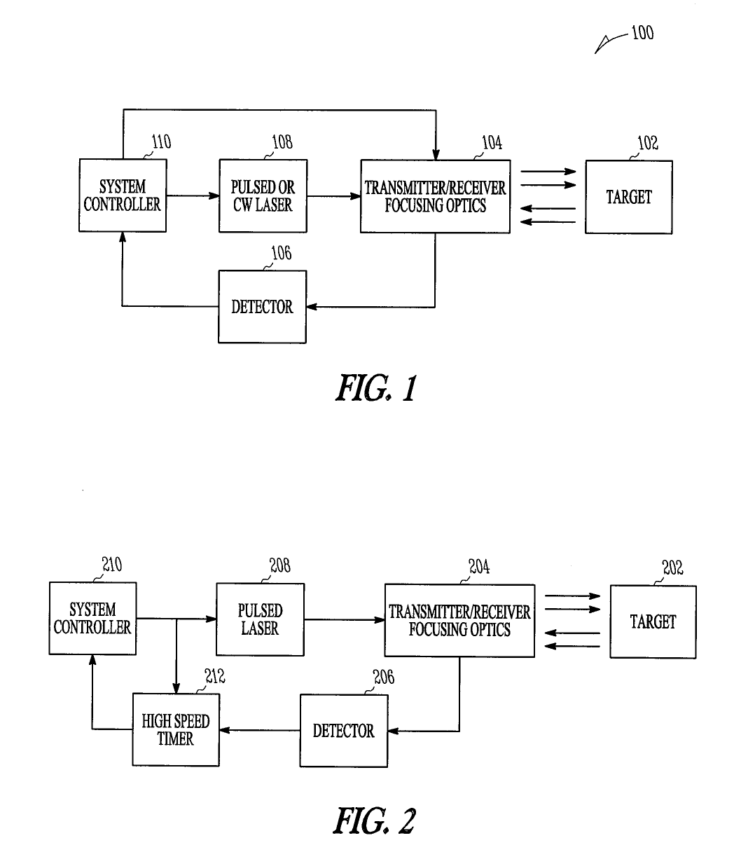

FIG. 2 is a block diagram of the optical range sensor system 200 in FIG. 1, according to an example embodiment. Optical range sensor system 100 includes a system controller 210, a pulsed laser 208, the transmitter/receiver 204, a high speed timer 212 and the detector 206. Also shown in FIG. 2 is a target 102 that may be located at a distance from the transmitter/receiver optics 204. System controller 210 is communicatively coupled to pulsed laser 206 and high speed timer 212. Pulsed laser 208 is coupled to the high-speed timer and the transmitter/receiver focusing optics 204 which in turn is coupled to detector 204.

In some embodiments, system controller 210 determines the range of target 202 by a time-of-flight measurement of a ranging signal and reduces the output power of laser 208 to the minimum required for target detection and/or identification. In some embodiments, system controller 210 provides a control signal to the pulsed laser 208 based on the target range calculated using the pulsed laser 208 and detector 206. In some embodiments, system controller 210 provides a control signal to the laser 208 and/or high-speed timer 212 to change the pulse width of the output pulse of pulsed laser 208 and also progressively lower the intensity of the pulse to prevent injury of retinal tissue of personnel located close to target 202 or in the path of the pulses. In some embodiments, the power of the output pulse from pulsed laser 208 is lowered such that it generates pulses having a pulse energy that is not sufficient to injure retinal tissue of personnel located between laser 208 and target 202.

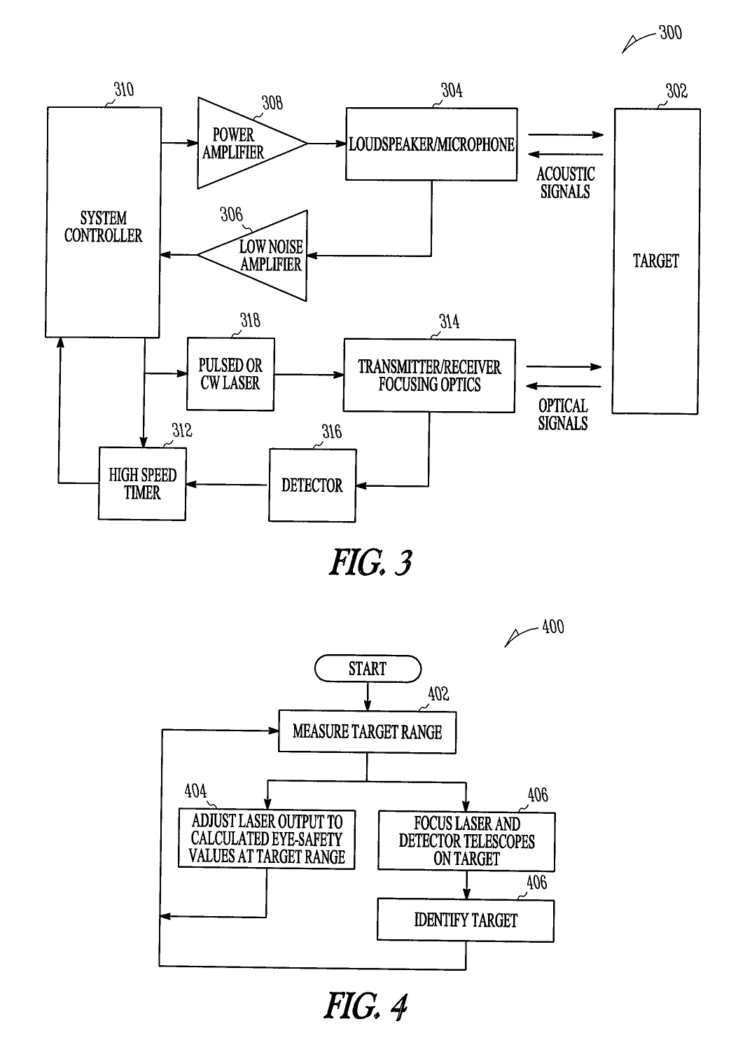

FIG. 3 illustrates a block diagram of an integrated sensor system 300 using both acoustic and optical signals, according to an example embodiment. In some embodiments, system 300 includes a system controller 310, a power amplifier 308, a loudspeaker/microphone system 304, a low noise amplifier 306, laser 318, transmitter/receiver focusing apparatus 314, detector 106 and high speed timer 312. Additionally, FIG. 3 shows a target 302 that may be located at a distance from the transmitter/receiver focusing apparatus 314. In some embodiments, system controller 310 is coupled to a power amplifier 308 which in turn is coupled to drive a loudspeaker/microphone system 304 that generates and receives ultrasonic pulses. In some embodiments, system controller 310 is coupled to low noise amplifier 306 that receives reflected ultrasonic pulses from target 302 and provides an amplified “return” signal to system controller 310. In some embodiments, the combination that includes loudspeaker/microphone system 304, power amplifier 308, low-noise amplifier 306 and system controller 310 functions as and provides a range measuring system. In some embodiments, system controller 310 in conjunction with the loudspeaker/microphone system 304 measures the acoustic time-of-flight to and from the target to determine the target range.

In some embodiments, the system controller 310 is coupled to laser 318 and high-speed timer 312. In some embodiments, laser 318 is configured to generate laser pulses and is coupled to the transmitter/receiving focusing optics 314 which in turn is coupled to detector 316 which is adapted to measure the reflected laser light from target 302. In some embodiments, laser 318 provides a continuous wavelength (CW) laser signal. In some embodiments, system controller 310 generates electrical signals that are used to control the laser pulses of laser 318. In some embodiments, the output laser power of laser 318 is reduced by system controller 310 to a minimum energy required for target detection based on the range to the target determined from the acoustic measurement of the target range.

In some embodiments, the target range may be measured using an optical signal generated by laser 318 and measuring the time of flight to and from the target. In some embodiments, for slow moving targets and/or targets at a short range, the target range is measured using laser 318 and detector 316. In some embodiments, for faster moving targets and/or targets at a longer range, the target range is measured using laser 318 and detector 316. In some embodiments the pulse repetition frequency is altered by the system controller 310 based on the target range measured using either of the loudspeaker/microphone system 304 or the laser 318 and detector 316. In some embodiments, multiple lasers and detectors that are coupled to system controller 310 may be used for the triangulation of target 302.

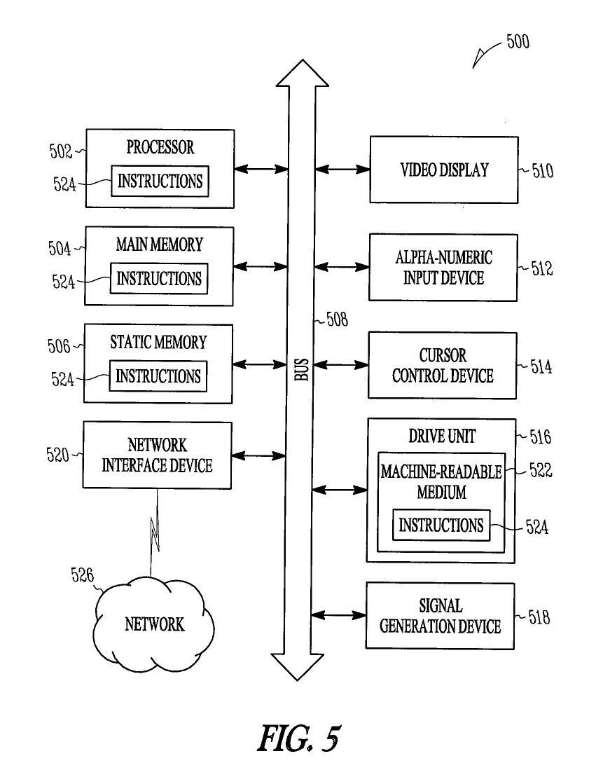

FIG. 4 is a flowchart illustrating a method 400 for providing eye-safety during sensing of target ranges, according to an example embodiment.

At 402, method 400 includes measuring the target range from an observer to a target using a ranging system 100, 200 or 300. In some embodiments, the ranging system includes laser 108, detector 106 and transmitter/receiver focusing optics 104 as shown in FIG. 1. In some embodiments, measuring the target range to a target includes using a ranging system including a pulsed laser 208, high speed timer 212, detector 106 and transmitter/receiver focusing optics 104 as shown in FIG. 2. In some embodiments, measuring the target range to a target includes using a ranging system including a loudspeaker/microphone system 304, as shown in FIG. 3 that generates and receives ultrasonic pulses to measure close ranges (below 10 meters). In some embodiments, for longer ranges (over 10 meters), measuring the target range includes measuring the time of flight of an electromagnetic ranging signal to and from the target or using auto-focusing based on contrast optimization.

At 404, method 400 includes adjusting laser output to calculated eye-safety values at target range. In some embodiments, adjusting the laser output to calculated eye safety values includes adjusting the peak energy of laser output pulse from laser 108, 208 such that it has sufficient energy to allow measurement of target range but does not have sufficient energy to injure retinal tissue.

At 406, method 400 includes focusing laser and detector telescopes on target 102. In some embodiments, focusing laser and detector telescopes includes focusing transmitter/receiver focusing optics 104 based on input from system controller 110, 210 or 310.

At 408, method 400 includes identifying the target. In some embodiments, identifying the target includes using a laser pulse from laser 108, 208 having a detecting energy not sufficient energy to injure retinal tissue located in the close vicinity of the target. In some embodiments, method 400 includes estimating the range from an observer to a target using a first energy pulse and calculating the minimum energy required for a target detecting energy pulse to detect the target. In some embodiments, method 400 includes monitoring the target at the estimated range using the target detecting energy pulse having the calculated minimum energy, wherein calculating the minimum energy required for the target detecting energy pulse includes calculating the minimum energy such that the target detecting energy pulse does not have sufficient energy to injure retinal tissue. In some embodiments of method 400, estimating the range from the observer to the target is performed by measuring the time of flight of an energy pulse to and from the target. In some embodiments of method 400, estimating the range from the observer to the target includes using auto-focusing based on contrast optimization.

FIG. 5 is a block diagram illustrating a machine in the example form of a computer system 500, within which a set of sequence of instructions for estimating the pulse energies in an optical range sensor system as discussed herein may be executed.

In some embodiments, the computer system 500 which represents the system controller 110, 210, 310 described herein may be a server computer, a client computer, a personal computer (PC), a tablet PC, a set-top box (STB), a Personal Digital Assistant (PDA), a cellular telephone, a web appliance, a network router, switch or bridge, or any machine capable of executing a set of instructions that specify actions to be taken by that machine. Further, while only a single machine is illustrated, the term “machine” shall also be taken to include any collection of machines that individually or jointly execute a set of instructions to perform any one or more of the methodologies discussed herein.

The example computer system 500 includes a processor 502 (e.g., a central processing unit (CPU) a graphics processing unit (GPU) or both), a main memory 504 and a static memory 506, which communicate with each other via a bus 508. The computer system 500 may further include a video display unit 510 (e.g., a liquid crystal display (LCD) or a cathode ray tube (CRT)). The computer system 500 also includes an alphanumeric input device 512 (e.g., a keyboard), a cursor control device 514 (e.g., a mouse), a disk drive unit 516, a signal generation device 518 (e.g., a speaker) and a network interface device 520. The disk drive unit 516 includes a computer-readable medium 522 on which is stored one or more sets of instructions (e.g., software 524) embodying any one or more of the methodologies or functions described herein. In some embodiments, the computer readable medium 522 is encoded with instructions, wherein the instructions when executed comprises measuring a range to a target using a ranging system by measuring the time of flight of a ranging signal (e.g. ultrasonic audio pulse, electromagnetic pulse) to and from the target, the first ranging signal having an energy sufficient to locate the target. In some embodiments, the computer readable medium 522 is encoded with instructions wherein the instructions when executed includes detecting the target using a detection system generating a target detection signal, the target detection signal having a peak energy determined based on the range to the target measured by the first detection system.

In some embodiments, the computer readable medium 522 is encoded with instructions wherein the instructions when executed includes identifying the target includes using the laser pulse having its peak energy not having sufficient energy in the optical waveband to injure retinal tissue located in the close vicinity of the target.

The software 524 may also reside, completely or at least partially, within the main memory 504 and/or within the processor 502 during execution thereof by the computer system 500, the main memory 504 and the processor 502 also constituting machine-readable media. The software 524 may further be transmitted or received over a network 526 via the network interface device 520.

While the machine-readable medium 522 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present invention. The term “machine-readable medium” shall accordingly be taken to include, but not be limited to, solid-state memories, optical and magnetic media.

The above-described steps can be implemented using standard programming techniques. The novelty of the above-described embodiment lies not in the specific programming techniques but in the use of the methods described to achieve the described results. Software programming code which embodies the present application is typically stored in permanent storage. In a client/server environment, such software programming code may be stored in storage associated with a server. The software programming code may be embodied on any of a variety of known media for use with a data processing system, such as a diskette, or hard drive, or CD ROM. The code may be distributed on such media, or may be distributed to users from the memory or storage of one computer system over a network of some type to other computer systems for use by users of such other systems. The techniques and methods for embodying software program code on physical media and/or distributing software code via networks are well known and will not be further discussed herein.

It will be understood that each element of the illustrations, and combinations of elements in the illustrations, can be implemented by general and/or special purpose hardware-based systems that perform the specified functions or steps, or by combinations of general and/or special-purpose hardware and computer instructions.

These program instructions may be provided to a processor to produce a machine, such that the instructions that execute on the processor create means for implementing the functions specified in the illustrations. The computer program instructions may be executed by a processor to cause a series of operational steps to be performed by the processor to produce a computer-implemented process such that the instructions that execute on the processor provide steps for implementing the functions specified in the illustrations. Accordingly, the figures support combinations of means for performing the specified functions, combinations of steps for performing the specified functions, and program instruction means for performing the specified functions.

While there has been described herein the principles of the application, it is to be understood by those skilled in the art that this description is made only by way of example and not as a limitation to the scope of the application. Accordingly, it is intended by the appended claims, to cover all modifications of the application which fall within the true spirit and scope of the invention.

1. A method, comprising:
measuring a range to a target using a ranging system by measuring the time of flight of a ranging signal to and from the target, the first ranging signal having an energy sufficient to locate the target; and
detecting the target using a detection system generating a target detection signal, the target detection signal having a peak energy determined based on the range to the target measured by the first detection system.

2. The method of claim 1, wherein the ranging signal includes an ultrasonic audio energy pulse and the target detection signal includes an electromagnetic laser energy pulse.

3. The method of claim 2, further comprising:
identifying the target using the laser pulse, wherein the peak energy of laser pulse does not have sufficient energy in the optical waveband to injure retinal tissue.

4. The method of claim 3, wherein identifying the target includes using the laser pulse having its peak energy not having sufficient energy in the optical waveband to injure retinal tissue at a distance substantially near the target.

5. A method comprising:
estimating the range from an observer to a target using a first energy pulse; and
calculating the minimum energy required for a target detecting energy pulse to detect the target; and
monitoring the target at the estimated range using the target detecting energy pulse having the calculated minimum energy, wherein calculating the minimum energy required for the target detecting energy pulse includes calculating the minimum energy such that the target detecting energy pulse does not have sufficient energy to injure retinal tissue.

6. The method of claim 5, wherein estimating the range from the observer to the target is performed by measuring the time of flight of an energy pulse to and from the target.

7. The method of claim 5, wherein estimating the range from the observer to the target includes using auto-focusing based on contrast optimization.

8. The method of claim 5, wherein the energy pulse used for estimating is an ultrasonic pulse,

9. The method of claim 5, wherein the energy pulse used for estimating is a laser pulse delivered at a low energy such that.

10. The method of claim 5, further comprising:
focusing on the target using focusing optics in conjunction with the target detection energy pulse.

11. A system, comprising:
a ranging system to estimate the range from an observer to a target using a ranging signal;
a target identification system including a laser and a detector to identify the target using a target identifying signal; and
a system controller coupled to the ranging system and the target identification system to calculate a minimum pulse energy required for a target identification signal to identify the target and monitor the target at the estimated range using the target identifying signal with the calculated minimum pulse energy.

12. The system of claim 11, further comprising:
focusing optics to focus the target detection signal on the target and the detector adapted to receive a portion of the electromagnetic signal reflected by the target.

13. The system of claim 11, further comprising a low noise amplifier coupled between the ranging system and the system controller.

14. The system of claim 11, further comprising a high speed timer coupled to the system controller, the laser and the detector.

15. The system of claim 11, wherein the ranging system includes a loud speaker generates an ultrasonic audio pulse and detects the portion of the ultrasonic audio pulse radiated from the target.

16. The system of claim 11, wherein the laser includes a light emitting diode and the detector includes a photodiode.

17. A computer readable medium encoded with instructions, wherein the instructions when executed comprising:
measuring a range to a target using a ranging system by measuring the time of flight of a ranging signal to and from the target, the first ranging signal having an energy sufficient to locate the target; and
detecting the target using a detection system generating a target detection signal, the target detection signal having a peak energy determined based on the range to the target measured by the first detection system.

18. The computer readable medium of claim 17, wherein the ranging signal includes an ultrasonic audio pulse and the target detection signal includes an electromagnetic pulse.

19. The computer readable medium of claim 17, further comprising:
identifying the target using the laser pulse, wherein the peak energy of laser pulse does not have sufficient energy in the optical waveband to injure retinal tissue.

20. The computer readable medium of claim 17, wherein identifying the target includes using the laser pulse having its peak energy not having sufficient energy in the optical waveband to injure retinal tissue located in the close vicinity of the target.
